(19) United States
(12) Patent Application Publication
(10) Pub. No.: US 2004/0204947 A1
(43) Pub. Date: Oct. 14, 2004

(54) System and method for generic business scenario management

(76) Inventors: Ruicheng Li, Singapore (SG); Aneesha Shenoy, Singapore (SG); Jayakumar Erat Kuttan, Singapore (SG)

Correspondence Address: KENYON & KENYON, 1500 K STREET, N.W., SUITE 700, WASHINGTON, DC, 20005, US

(21) Appl. No.: 10/400,459

(22) Filed: Mar. 28, 2003

(51) Int. Cl. G06F 17/60

(52) U.S. Cl. 705/1

(57) ABSTRACT

A method and system for generic business scenario management. According to one embodiment, a generic workbench component provides business process functionality to each of a plurality of business scenarios, a localization component provides business process functionality specific to one of the plurality of business scenarios, and a data exchanger interface component dynamically passes information between the generic workbench component and the localization component, wherein the generic workbench component centrally manages the business process functionality of the localization component via the data exchanger interface component.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

Many organizations utilize enterprise software to implement various business scenarios. A business scenario usually comprises a set of inter-related business processes to be performed in order to complete the business scenario. For example, a business scenario could be termination of employee, increment (salary increase) to be given to employee, or pension administration for employees.

A business scenario can be quite complex, as illustrated generally in FIG. 1 and specifically in FIG. 2. Depending on the particular business scenario to be modeled, a business scenario (100) may include one or more process scenarios (105, 145), sub process scenarios (110, 130, 140, 150, 170, 175), process tasks (115, 125, 155, 165) and activities (120, 135, 160).

As a specific example, FIG. 2 illustrates a hierarchy for a German pension administration business scenario in a human resources (“HR”) management context. Pension administration 200 may include process scenarios basic assessment 205 and adjustment for child allowance 245, which are different types of actions that could be requested by employees within the pension administration business scenario. If an employee requests a basic assessment (205), an HR officer may need to perform sub process scenarios master data changes 210, seniority calculation 230, assessment 240, etc. These sub process scenarios represent processes to be performed to complete the process scenario. Master data changes 210 may include process tasks pension changes 215 and organizational changes 225. Pension changes 215 may require activities 220, which could represent displaying, changing, deleting, printing, approving, activating, etc. Process scenario adjustment for child allowance 245 is similar to basic assessment 205, except that a seniority calculation (230) is not required. Other business scenarios, of course, can be expected to involve different processes from those shown in FIG. 2.

The complexity of such business scenarios is often reflected in the development and use of current enterprise software implementations of business scenarios. For example, suppose an organization desires a software implementation of the above pension administration business scenario. The developer is likely to create separate modules representing each sub process of the business scenario, and then provide access to them via a menu-driven user interface tool for the end user. When the end user selects a particular sub process menu item (such as seniority calculation 230), the tool launches a separate process environment that deals only with that particular sub process environment.

This current software implementation is problematic for both the developer and the end user. From the developer's perspective, creating and interfacing a large number of separate modules to ensure compliance with the overall business scenario process flow is difficult, prone to error and hard to modify. For example, if the organization were to desire local application of the pension administration tool (i.e., to tailor the tool for use in a different country or region), completely new programming of the entire business process may be required or, at the least, line-by-line modification of the existing process would be required. From the end user's perspective, using a tool that restricts the user's view of the entire business scenario to the particular sub process at hand makes management of the entire business scenario difficult or even impossible.

Accordingly, there is a need in the art for a system and method that manage the life cycle of any business scenario while enabling localization of any particular business scenario.

### SUMMARY OF THE INVENTION

Embodiments of the present invention provide a framework for generic business scenario management. According to one embodiment, a generic workbench component provides business process functionality to each of a plurality of business scenarios, a localization component provides business process functionality specific to one of the plurality of business scenarios, and a data exchanger interface component dynamically passes information between the generic workbench component and the localization component, wherein the generic workbench component centrally manages the business process functionality of the localization component via the data exchanger interface component.

### BRIEF DESCRIPTION OF THE DRAWINGS

FIG. 1 is a block diagram that depicts a hierarchy of a generic business scenario in accordance with an embodiment of the present invention.

FIG. 2 is a block diagram that depicts a hierarchy of a pension administration business scenario in accordance with an embodiment of the present invention.

FIG. 3 is a sequence diagram that depicts a process flow for a pension administration business scenario in accordance with an embodiment of the present invention.

FIG. 4 is a screen shot of a pension workbench in accordance with an embodiment of the present invention.

FIG. 5 is a sequence diagram that depicts a process flow for a termination business scenario in accordance with an embodiment of the present invention.

FIG. 6 is a screen shot of a termination and redundancy workbench in accordance with an embodiment of the present invention.

FIG. 7 is a generic process flow chart for business scenario management in accordance with an embodiment of the present invention.

FIG. 8 is a block diagram that depicts a client computing device in accordance with an embodiment of the present invention.

FIG. 9 is a block diagram that depicts a network architecture for an enterprise system in accordance with an embodiment of the present invention.

FIG. 10 is a block diagram that depicts a component architecture for managing a business scenario in accordance with an embodiment of the present invention.

FIG. 11 is a block diagram that depicts a user interface for business scenario management in accordance with an embodiment of the present invention.

FIG. 12 is a flow chart that depicts workbench engine management of a business scenario in accordance with an embodiment of the present invention.

FIG. 13 is a flow chart that depicts creation of a new business scenario in accordance with an embodiment of the present invention.

FIG. 14 is a data model for business scenario management in accordance with an embodiment of the present invention.

FIG. 15 is a screen shot of a workbench engine configuration tool in accordance with an embodiment of the present invention.

FIG. 16 is a screen shot of a configuration tool for assigning a process scenario to a process group in accordance with an embodiment of the present invention.

FIG. 17 is a screen shot of a configuration tool for assigning a process group to a grouping of sub process scenarios and user groups in accordance with an embodiment of the present invention.

FIG. 18 is a screen shot of a configuration tool for assigning a sub process scenario to a grouping of sub process scenarios and to a status group in accordance with an embodiment of the present invention.

FIG. 19 is a screen shot of a configuration tool for assigning a sub process scenario to a localization program and screen in accordance with an embodiment of the present invention.

FIG. 20 is a screen shot of a configuration tool for assigning a transaction to a business scenario in accordance with an embodiment of the present invention.

FIG. 21 is a screen shot of a configuration tool for defining business process flow rules between sub process scenarios in accordance with an embodiment of the present invention.

FIG. 22 is a screen shot of a configuration tool for defining business process flow rules between process status within a sub process scenario in accordance with an embodiment of the present invention.

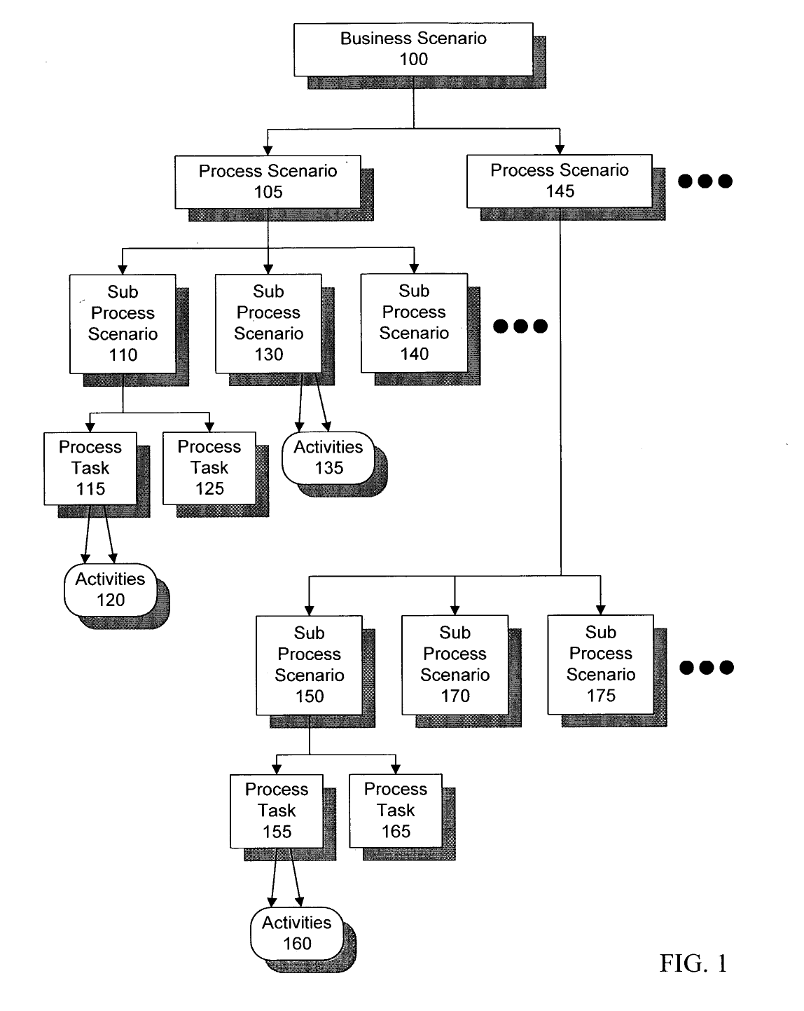

### DETAILED DESCRIPTION

### Overview

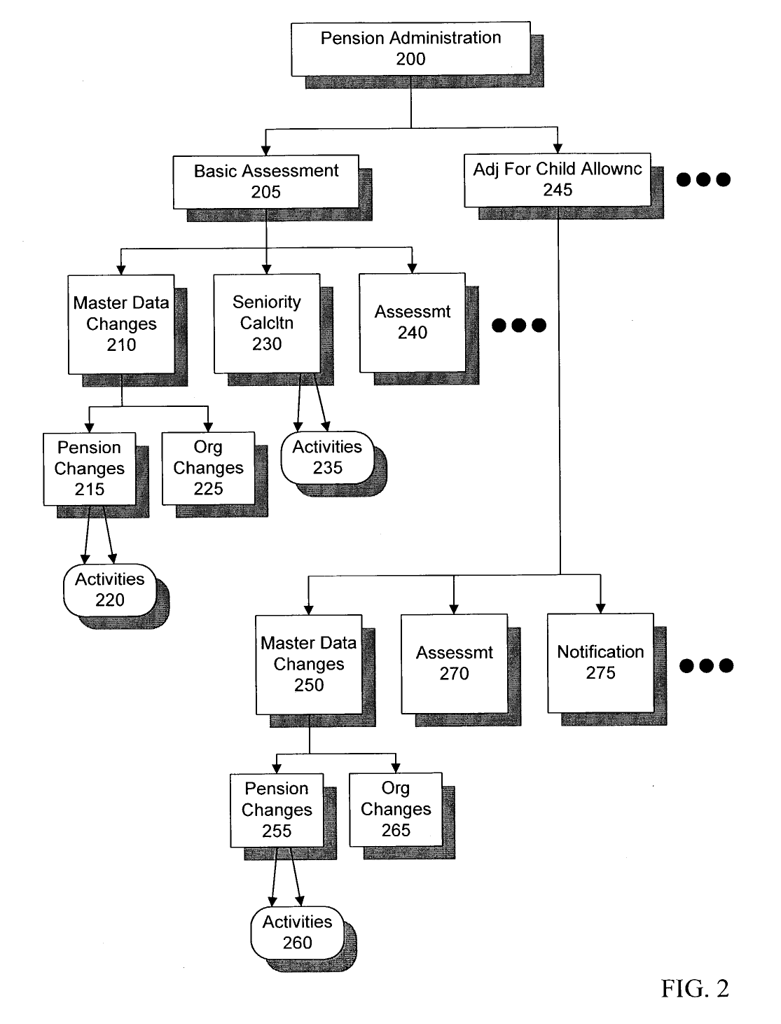

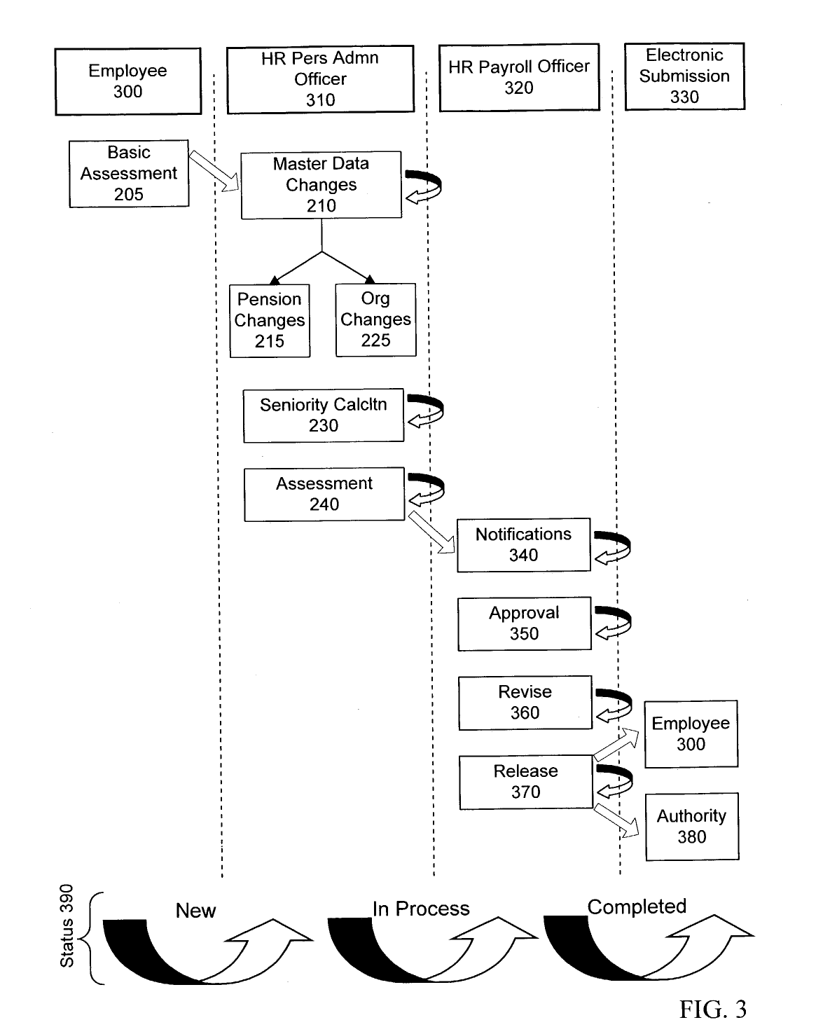

Embodiments of the present invention provide a framework for a generic workbench that renders a holistic view of an entire business scenario and manages the entire business scenario along with its sub process scenarios during its life cycle. To illustrate by example, FIG. 3 depicts a sequence diagram of a complete process flow for process scenario basic assessment 205 of the pension administration business scenario illustrated in FIG. 2. All of the processes in FIG. 3 are performed through the utilization of the generic workbench.

The process flow begins when employee 300 enters a request to calculate pension (process 205). When this occurs, the generic workbench may mark the status of process scenario basic assessment 205 as “new” (status 390). In FIG. 3, each curved arrow next to a process box denotes the status of each sub process scenario, which is also managed by the generic workbench. Once the request is entered, an end user such as HR personnel administration officer 310 commences processing the pension request by performing some changes to the master data of employee 300 (process 210). These changes relate to pension data (process 215) and organizational data (process 225). As this is occurring, the generic workbench marks the status of the process scenario as “in process” (status 390). HR officer 310 next performs a seniority calculation for employee 300 (process 230), and then runs payroll in simulation mode (process 240). Once this is completed, HR payroll officer 320 generates notification reports (process 340), which go through the approved process (process 350), are revised if required (process 360) and released (step 370) through electronic submission (330) to employee 300 and the respective authority 380. Upon this release, the generic workbench marks the status of the process scenario as “completed” (status 390).

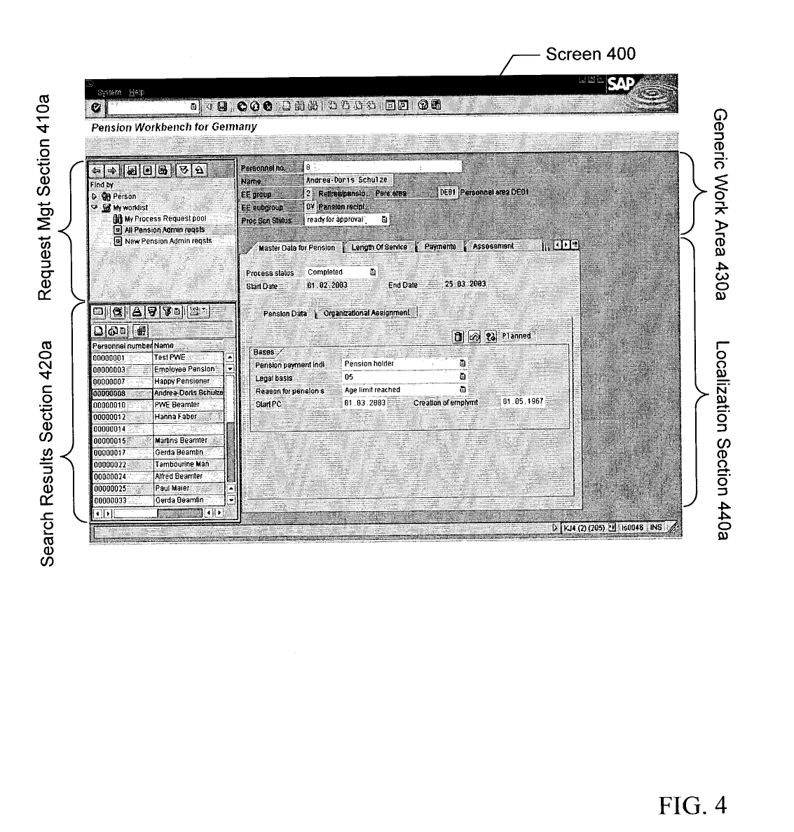

Screen 400 of FIG. 4 illustrates a user interface for the generic workbench that implemented the process flow of FIG. 3 in accordance with an embodiment of the present invention. Through screen 400, the generic workbench renders a holistic view of the entire pension administration business scenario and it sub process scenarios for the end user (e.g., employee 300, HR officers 310 and 320). This view includes request management section 410a and search results section 420a, both of which enable HR officers 310 and 320 to manage employee 300's pension administration request, general work area 430a, which displays status information for the entire business process scenario (the “ready for approval” label in the “Proc Scn Status” field of generic work area 430a), and localization section 440a, which displays through each tab the corresponding sub process scenario functionality (e.g., tab “Master Data for Pension” corresponds to sub process scenario 210, tab “Length of Service” corresponds to sub process scenario 230, etc.) and status information specific to each sub process scenario (e.g., the “Completed” label in the “Process status” field).

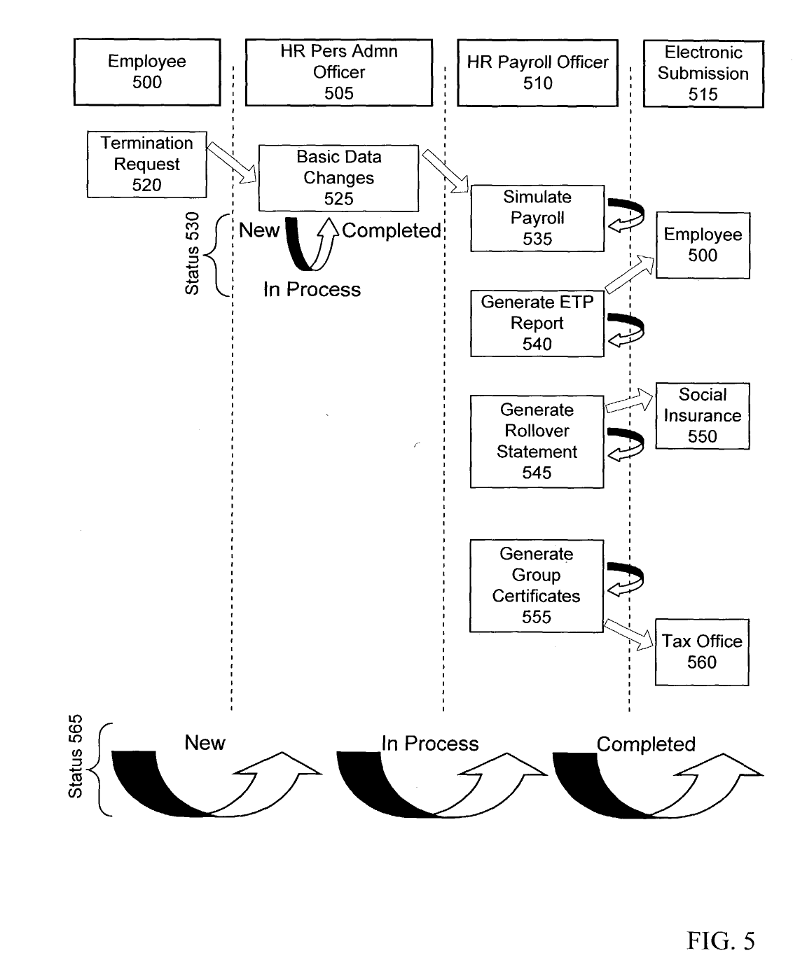

What makes the generic workbench “generic” is that it can be used to manage and process any business scenario. Common business scenario elements are built into the generic workbench (e.g., those shown in request management section 410a and search results section 420a), while only localization elements of a business scenario need to be specified (e.g., the sub process scenarios shown in localization section 440a). For example, the generic workbench may also be used for an Australian termination business scenario. FIG. 5 depicts a sequence diagram of a complete process flow for process scenario termination request 520. (Again, all of the processes in FIG. 5 are performed through the utilization of the generic workbench).

The process flow begins when employee 500 enters a termination request in the generic workbench (process 520). When this occurs, the generic workbench marks the status of process scenario termination request 520 as “new” (status 565). Once the request is entered, HR personnel administration officer 505 commences processing the termination request by inputting the termination details into the master data of employee 500 (process 525). As this is occurring, the generic workbench marks the status of the process scenario as “in process” (status 565), in addition to marking the status of the sub process scenario 525 as either “new,” “in process,” or “completed” (status 530) as appropriate. Next, HR payroll officer 510 simulates payroll and time evaluation (process 535) and generates a termination payments report (process 535), an insurance report (process 545) and a tax report (process 560). Once these reports are submitted through electronic submission (515) to employee 500, social insurance 550 and tax office 560, respectively, the generic workbench marks the status of the process scenario as “completed” (status 565).

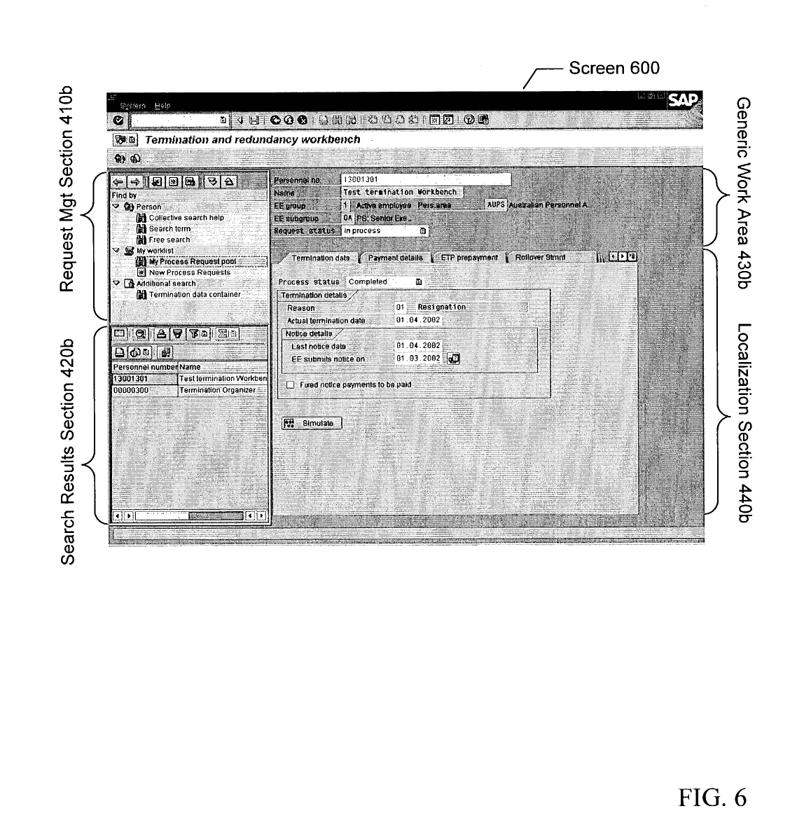

Screen 600 of FIG. 6 illustrates the user interface for the generic workbench that implemented the process flow of FIG. 5 in accordance with an embodiment of the present invention. The user interface components request management section 410b, search results section 420b, general work area 430b and localization section 440b are the same as in FIG. 4, except in this case they relate to the Australian termination business scenario. Note that in screen 600 the generic workbench provides the end user with the current status of both the process scenario (the “in process” label in the “Request status” field of generic work area 430b) and the selected sub process scenario (the “completed” label in the “Process status” field of localization section 440b).

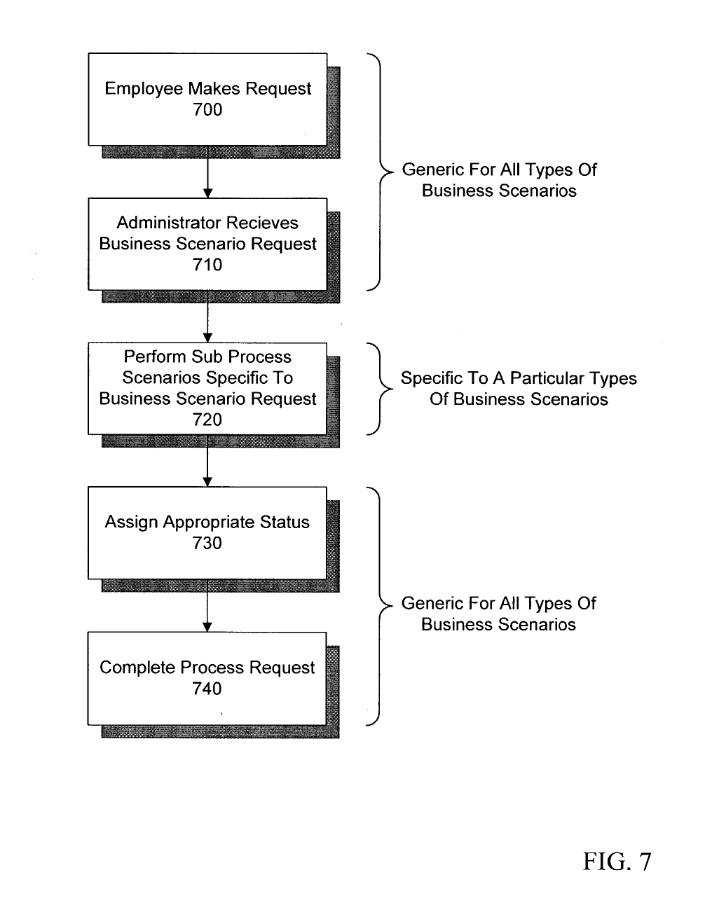

As stated above, the generic workbench has common business scenario elements built in, while only localization elements of a business scenario need to be specified. This ideology is further illustrated in FIG. 7, which depicts a generic process flow chart for business scenario management in accordance with an embodiment of the present invention. Again, all of the steps in FIG. 7 are performed through the generic workbench.

For any particular business scenario implemented by generic workbench, an employee first makes a request (step 700), and then an administrator receives the request (step 710). At this point, the administrator performs sub process scenarios specific to the request (step 720), at which point the appropriate status for the sub process scenario is assigned (step 730). After completion of all of the sub process scenarios, the processing of the request is completed (step 740).

In this process flow, all steps except for step 720 are generic for all types of business scenarios, so they are built into the generic workbench. Thus, only the step specific to a particular type of business scenario needs to be specified by a developer and plugged into the generic workbench. This framework greatly simplifies development of the generic workbench with respect to local application of a business scenario, since only the localization elements need to be modified. Additionally, since the generic workbench acts as a central management system to the localization elements, localization element development is further simplified because the localization elements need only interface with the central generic workbench, and not with the mess of other localization elements, to ensure compliance with the overall business scenario process flow.

### Computer Architecture

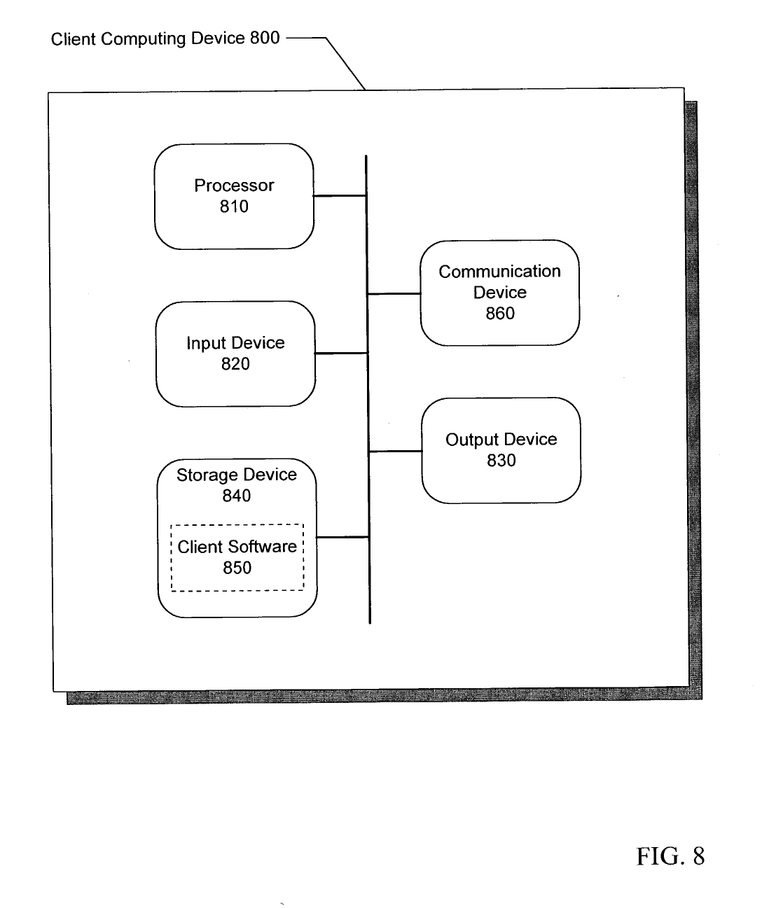

FIG. 8 is a block diagram depicting the internal structure of client computing device 800 in accordance with an embodiment of the present invention. Client computing device 800 may be a personal computer, handheld personal digital assistant (“PDA”), or any other type of microprocessor-based device. Client computing device 800 may include a processor 810, input device 820, output device 830, storage device 840, client software 850 and communication device 860.

Input device 820 may include a keyboard, mouse, pen-operated touch screen, voice-recognition device, or any other device that provides input from a user. Output device 830 may include a monitor, printer, disk drive, speakers, or any other device that provides output to user.

Storage device 840 may include volatile and nonvolatile data storage, including one or more electrical, magnetic or optical memories such as a RAM, cache, hard drive, CD-ROM drive, tape drive or removable storage disk. Communication device 860 may include a modem, network interface card, or any other device capable of transmitting and receiving signals over a network.

Client software 850, which may be stored in storage device 840 and executed by processor 810, may include a graphical user interface (“GUI”) to a client/server application, such as a mySAP HR application that embodies the functionality of the present invention.

The components of client computing device 800 may be connected via an electrical bus or wirelessly.

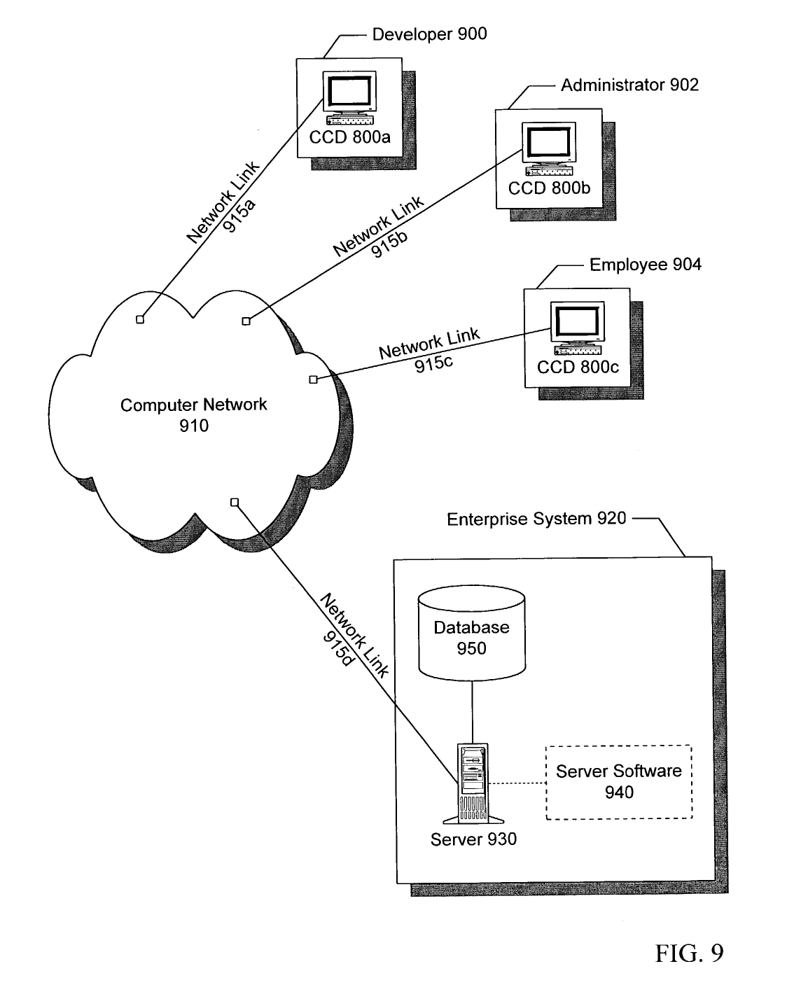

FIG. 9 is a block diagram depicting a network architecture for an enterprise system in accordance with an embodiment of the present invention. According to one particular embodiment, when developer 900, administrator 902 or employee 904 invokes the mySAP HR application GUI that is part of enterprise system 920, client computing device 800 sends and receives via client software 850 requests to and from server 930 running server software 940 via network link 915 and computer network 910.

Network link 915 may include telephone lines, DSL, cable networks, T1 or T3 lines, wireless network connections, or any other arrangement that provides a medium for the transmission and reception of computer network signals. Computer network 910 may include any type of packet-based network, such as a wide-area network (“WAN”) (e.g., the Internet) and/or a local-area network (“LAN”) (e.g., an intranet or extranet).

Computer network 910 may implement any number of communications protocols, including TCP/IP (Transmission Control Protocol/Internet Protocol). The communication between CCD 800 and server 930 may be secured by any Internet security protocol, such as SSL (Secured Sockets Layer).

Server 930 includes a processor and memory for executing program instructions, as well as a network interface (not shown), and may include a collection of servers working in tandem to distribute the network functionality and load. In one particular embodiment, server 930 may include a combination of enterprise servers such as an application server and database server, all of which could be manufactured by Sun Microsystems, Inc. Server 930 could run an operating system such as UNIX® (or any variant thereof). Database 950 may be part of a relational database program, such as MySQL® that may be run as a process by a database server within the UNIX® operating system, for example. Server software 940 may take the form of custom-written programs and libraries that run, either interpreted or compiled, as a result of requests received by server 930. These programs may be written in any programming language, such as ABAP, C or C++. Server software 940 may be built on an enterprise application platform, such as the SAP R/3 system, and may include a mySAP HR application embodying the functionality of the present invention.

### Generic Workbench

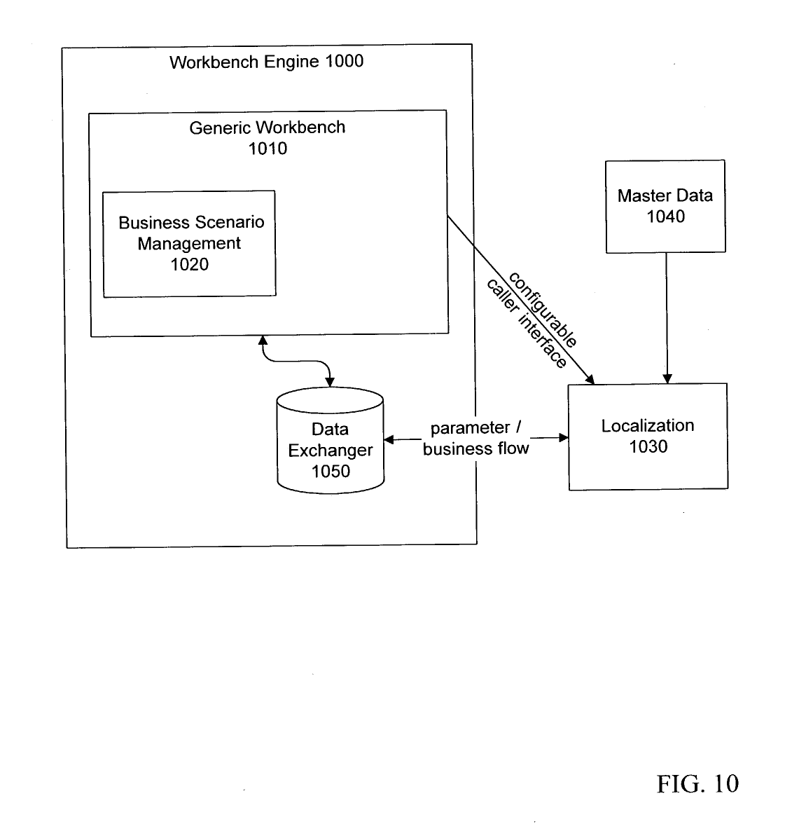

FIG. 10 illustrates a component architecture for the generic workbench in accordance with an embodiment of the present invention. As described above, generic workbench 1010 includes built in common business scenario elements (part of business scenario management 1020) while enabling localization elements of a specific business scenario (part of localization 1030) to be plugged into generic workbench 1010 via a configurable caller interface. Localization 1030 is created by master data 1040, which may be generic tool that enables developers to create the associated screens and functionality embodied in localization 1030.

Business scenario management 1020 may not only include common business scenario elements distinct from those found in localization 1030 (e.g., request management functionality), but may additionally include central management functionality that interfaces directly with localization 1030, such as status and business rule management. The status management functionality enables generic workbench 1010 to manage the status of both the complete business scenario as well as the localization elements, while the business rule management functionality enables generic workbench 1010 to perform business rule checks on the localization elements as defined through the configurable caller interface. Business scenario management 1020 may also include functionality related to authorization management, search engines, Internet connectivity and activity control.

Workbench engine 1000 is the runtime framework for generic workbench 1010. Since generic workbench 1010 and localization 1030 are independent entities, workbench engine 1000 utilizes data exchanger 1050 to dynamically pass information between generic workbench 1010 and localization 1030 at runtime. This information is utilized by generic workbench 1010 to act in its central management role.

Data exchanger 1050 may be implemented as an interface class using, for example, ABAP OO technology. Data exchanger 1050 may be filled and retrieved by generic workbench 1010 and/or localization 1030 based on certain events. In one embodiment, data exchanger 1050 may include a parameter exchanger interface class and a business flow exchanger interface class.

The parameter exchanger interface class may be utilized by localization 1030 to fetch certain data variables available in generic workbench 1010 for processing. For instance, some useful data variables could be the requesting employee's personnel number (“pernr”), the function code (“Fcode”) associated with an action taken by the employee in generic workbench 1010 (such as a code associated with the function “SAVE”), and the process scenario status (“Req_Status”). Events driving the exchange of these parameters could be the changing of selection and the exit of request, among other things.

Some exemplary ABAP code implementing this parameter exchange interface on behalf of generic workbench 1010 follows:

```
PROCESS BEFORE OUTPUT.
  . . .
  MODULE Load_data.
    CALL METHOD CL_HR_PBS_PARAM_EXCHANGER=>
    Load_Data
```

| | |
|---|---|
| EXPORTING | Var_Name = ‘Pernr’ |
| | Var_cont = Pernr. |

```
  ENDMODULE.
  CALL SUBSCREEN <localization> including ‘RPPBSTQ1’ ‘2001’.
  . . .
PROCESS AFTER INPUT.
  . . .
  MODULE Load_data.
      CALL METHOD CL_HR_PBS_PARAM_EXCHANGER=>
      Load_Data
```

| | |
|---|---|
| EXPORTING | Var_Name = ‘Fcode’ |
| | Var_cont = fcode. |

```
  ENDMODULE.
  CALL SUBSCREEN <localization>.
```

In the above code, generic workbench 1010 calls the parameter exchanger to load the personnel number of the requesting employee before calling localization screen “2001” relating to termination workbench “RPPBSTQ1”. And after an administrator makes a selection, generic workbench 1010 calls the parameter exchanger to load the function code associated with the user selection.

Some exemplary ABAP code implementing this parameter exchange interface on behalf of localization 1030 follows:

```
PROCESS BEFORE OUTPUT.
  . . .
  MODULE READ_DATA.
    CALL METHOD CL_HR_PBS_PARAM_EXCHANGER =>
    Fetch_Data
```

| | |
|---|---|
| EXPORTING | Var_Name = ‘Pernr’ |
| RECEIVING | Var_cont = Pernr. |

```
  ENDMODULE.
PROCESS AFTER INPUT.
  MODULE READ_DATA.
    CALL METHOD CL_HR_PBS_PARAM_EXCHANGER =>
    Fetch_Data
```

| | |
|---|---|
| EXPORTING | Var_Name = ‘Fcode’ |
| RECEIVING | Var_cont = Fcode. |

```
  ENDMODULE.
  . . .
  MODULE UPDATE_DATA.
    CALL METHOD CL_HR_PBS_PARAM_EXCHANGER =>
    Update_Data
```

| | |
|---|---|
| EXPORTING | Var_Name = ‘Req_stat’ |
| | Var_cont = Req_stat. |

ENDMODULE.

In the above code, localization 1030 calls the parameter exchanger to fetch the personnel number of the requesting employee before displaying localization screen “2001”. After an administrator inputs a value or makes a selection in localization screen “2001”, localization 1030 fetches the function code associated with the user selection, and then updates the parameter exchanger with the process scenario status.

The business flow exchanger interface class may similarly be utilized by localization 1030 to fetch certain data variables available in generic workbench 1010 for processing. For instance, some useful data variables could be the status of different sub process scenarios (in order to verify process flow), an error message generated and business process flow rules. Events driving the exchange of these parameters could be the changing of a process status, changing of a process scenario status and an error in a sub process scenario, among other things.

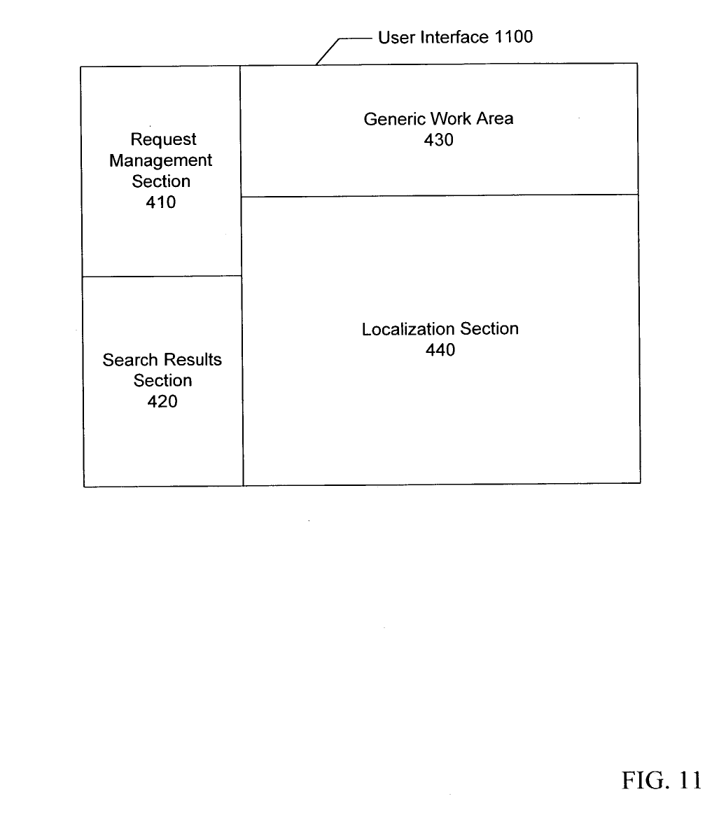

FIG. 11 depicts a user interface for business scenario management in accordance with an embodiment of the present invention. As shown in screen 400 of FIG. 4 and screen 600 of FIG. 6, generic workbench 1010 may provide user interface 1100, which includes request management section 410, search results section 420, general work area 430 and localization section 440.

FIG. 12 depicts the how workbench engine 1000 manages a business scenario in accordance with an embodiment of the present invention. First, workbench engine 1000 retrieves business scenario data from database 950 (step 1200) based on a transaction code (i.e., a business scenario identifier). Next, workbench engine 1000 populates user interface tabs based on the retrieved business scenario data (step 1210). Business scenario rules are then retrieved from database 950 (step 1220), as well as requests for the business scenario (step 1230). At this point, workbench engine 1000 waits for the end user to make a selection on the main screen of generic workbench 1010 (step 1240). Once a selection is made, workbench engine 1000 fills generic work area 430 with generic details of the business scenario (step 1250), fills data exchanger 1050 with the appropriate business scenario parameters (step 1260) and calls the corresponding localization screens (step 1270). Control of generic workbench 1010 is then turned over to localization 1030 until another selection is made on the main screen of generic workbench 1010.

### Development Framework

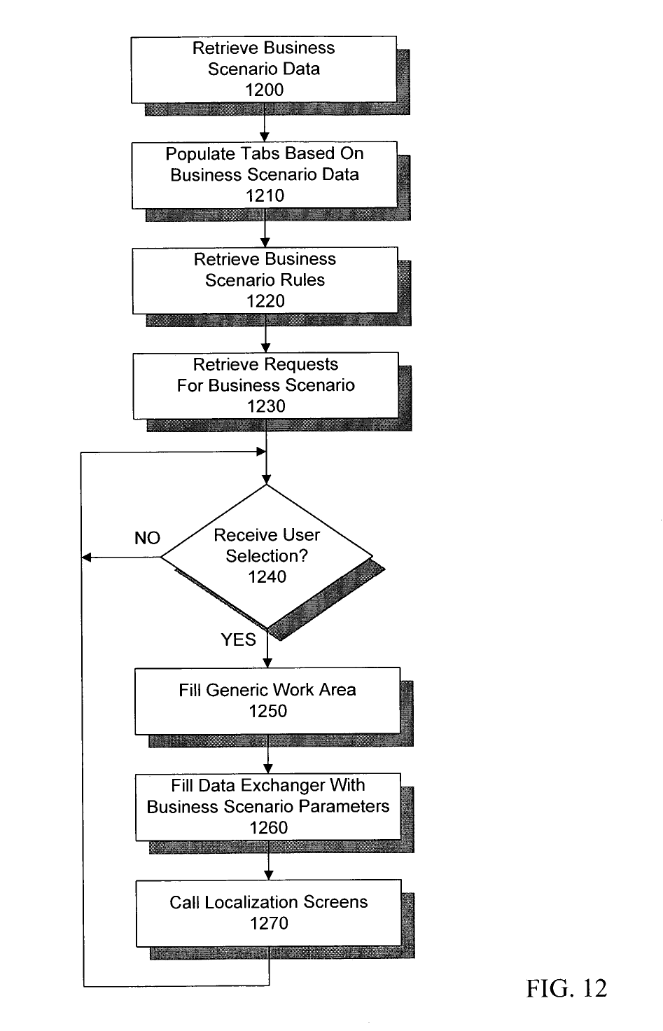

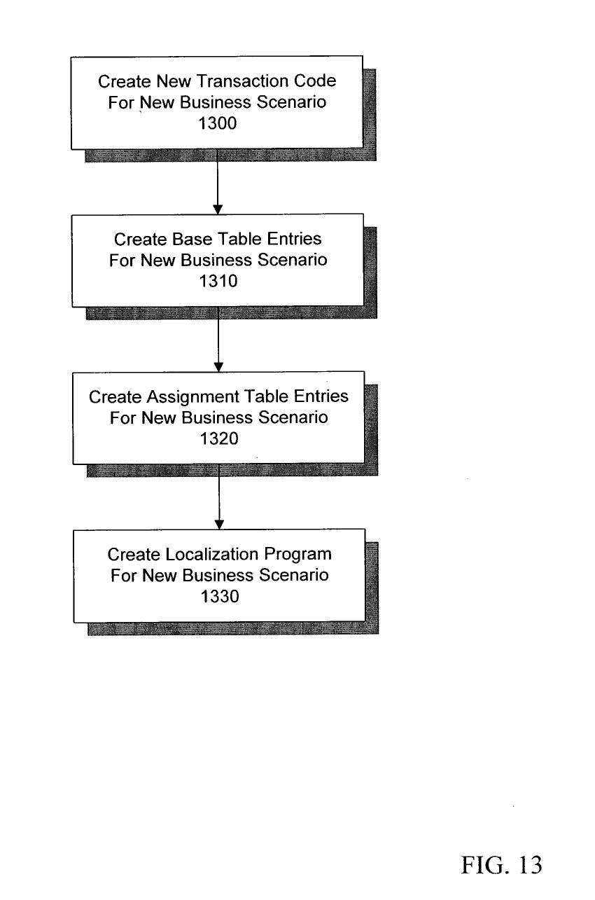

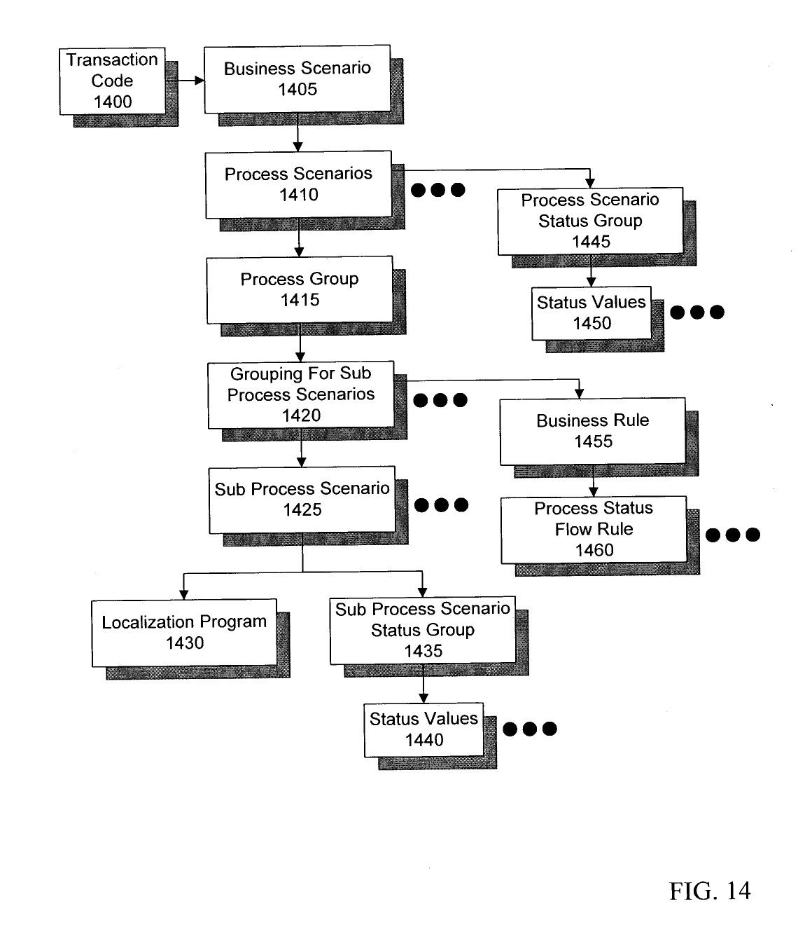

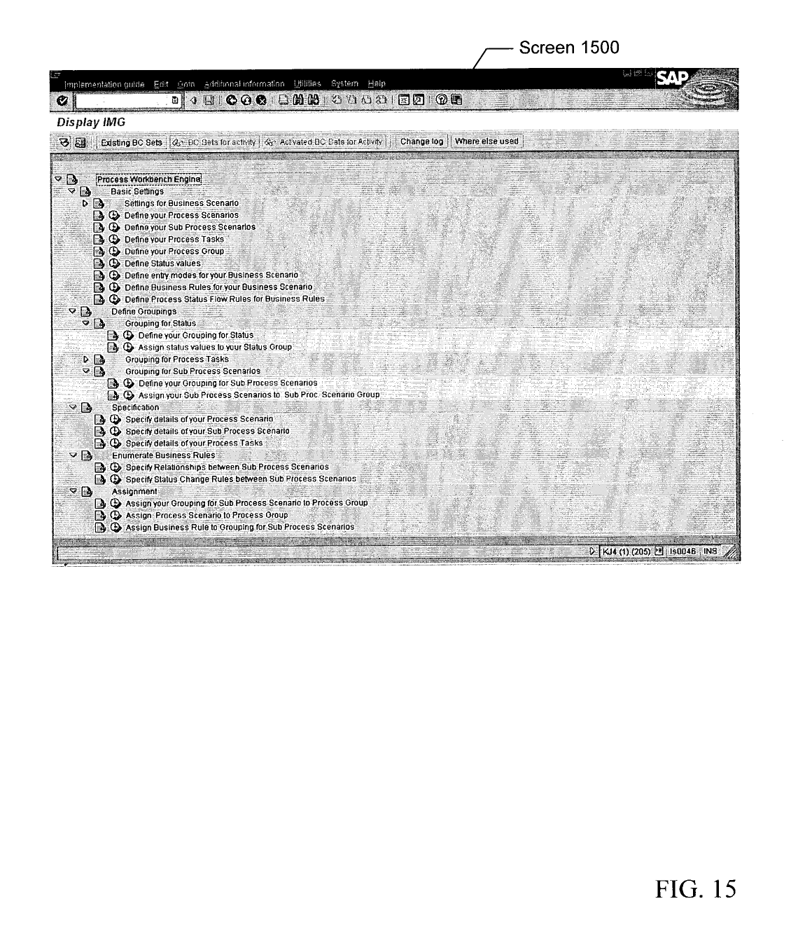

FIG. 13 depicts a process of creating a new business scenario based on the data model shown in FIG. 14. The data model elements may represent database tables in database 950. Screen 1500 of FIG. 15 illustrates a configuration tool that developers may utilize to perform the configuration steps of FIG. 13.

The first step in creating a new business scenario is to create a new transaction code for the new business scenario (step 1300) in table 1400 and assigning the transaction code to workbench engine 1000. The next step is to create base table entries for the new business scenario (step 1310). Based on the data model of FIG. 14, these entries may include:

Business Scenarios

The configuration tool enables the creation of a business scenario/request type for a particular country in table 1405 (e.g., German Pension Administration Request, etc.).

Process Scenarios

The configuration tool enables the creation of a process scenario for a business scenario in table 1410 (e.g., for German Pension Administration Request, the process scenarios basic pension assessment, adjustment assessment, etc.).

Sub Process Scenarios

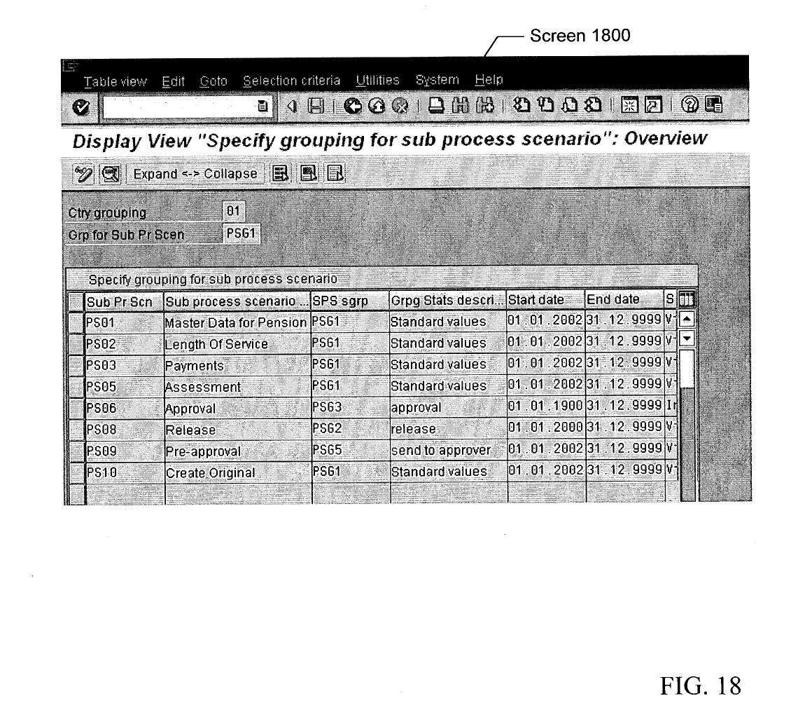

The configuration tool enables the creation of a sub process scenarios (e.g., for German Pension Administration Request: Termination data, Master Data for Pension, Length of Service, Payments, Assessment, etc.) in table 1425, and the creation of a grouping for sub process scenarios (e.g., “PSG1” for German Pension Administration Request) in table 1420. There can be several such groupings for a process scenario based on the role of the user (e.g., HR personnel officer 310, HR payroll officer 320, etc.). The configuration tool also enables the setting of the sub process scenarios' sequence in a database table as illustrated by screen 1800 of FIG. 18.

Process Status

The configuration tool enables the creation of a process status (e.g., “New,” “In Process,” “Completed,” etc.) in table 1440, and the creation of a grouping for process status (e.g., “PSG0”) in table 1435. The configuration tool enables the setting of the process status sequence in a database table.

Request Modes

The configuration tool enables the creation of request modes (e.g., ESS, Batch Mode, etc.) in a database table.

Process Group

The configuration tool enables the creation of a process group (i.e., grouping of users authorized to use business scenario) in table 1415.

The next step in the creation of a new business scenario is to create assignment table entries for the new business scenario (step 1320). Based on the data model of FIG. 14, these entries may include:

Assignment of Transaction Code

As illustrated in FIG. 20, the configuration tool enables the assignment of the transaction code (“HRPBSDEVA”) to the appropriate business scenario (“DEPA” German Pension Administration Request), country (“01” Germany) and object manager scenario (relating to user interface tool).

Assignment of Process Scenario

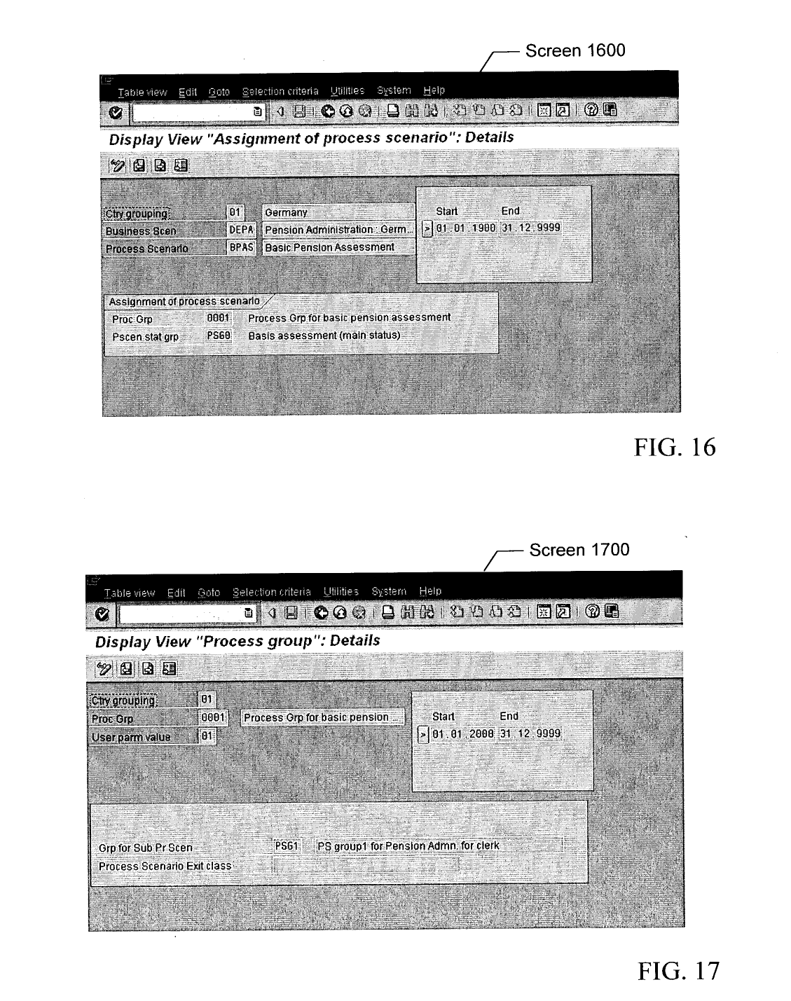

As illustrated in FIG. 16, the configuration tool enables the assignment of the process scenario (“BPAS” Basic Pension Assessment) to the business scenario (“DEPA” German Pension Administration Request), appropriate process group (“0001”) and process scenario status group ( “PSG0”).

Assignment of Process Group

As illustrated in FIG. 17, the configuration tool enables the assignment of the process group (“0001”) to the appropriate user group (“01”) and grouping for sub process scenario (“PSG1”).

Assignment of Sub Process Scenario

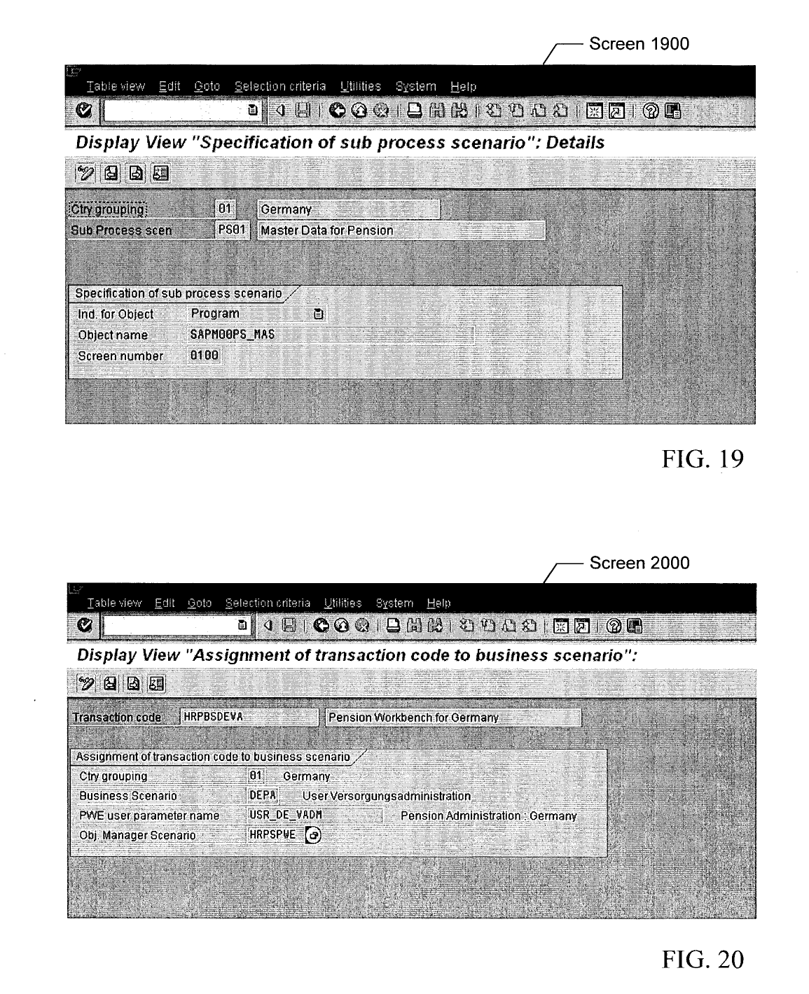

As illustrated in FIG. 19, the configuration tool enables the assignment of the sub process scenarios (“PS01”) to the appropriate localization program (“SAPM00PS_MAS”) and screen (“0100”). As illustrated in FIG. 18, the configuration tool also enables the assignment of a sub process scenario to a status group (e.g., “PSG1” for sub process scenario—Master Data for Pension).

Business Process Flow Rules

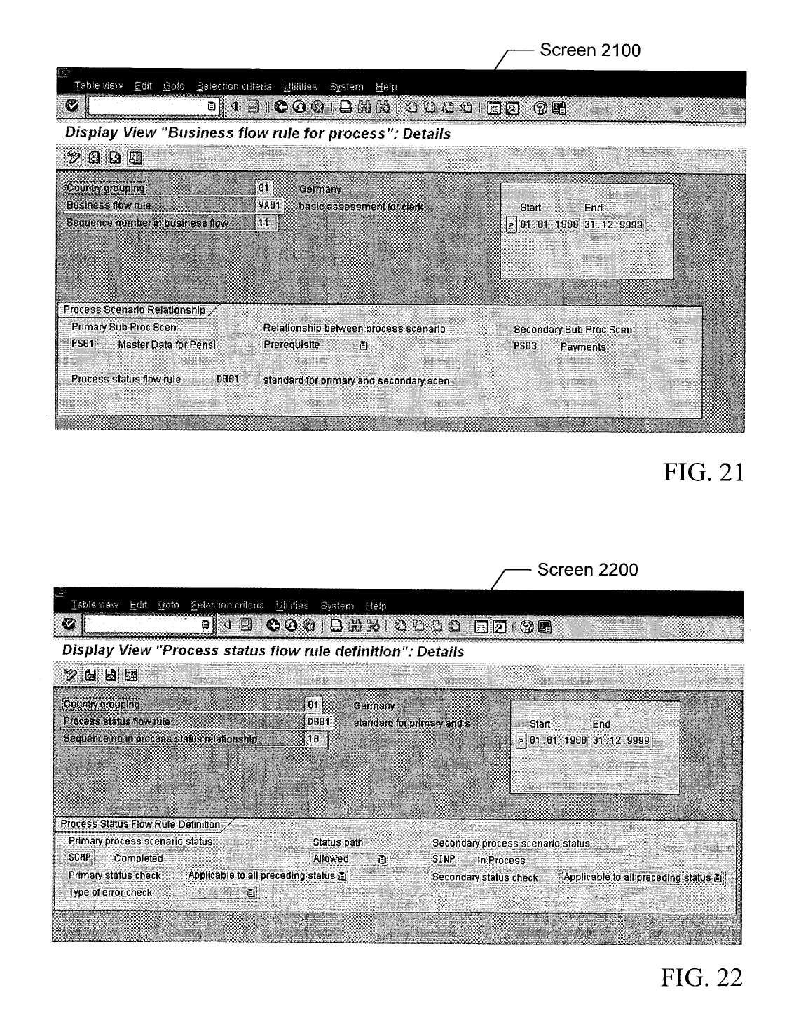

As illustrated in FIG. 21, the configuration tool enables the definition of rules for business process flow between sub process scenarios (the “Process Scenario Relationship” rules). As illustrated in FIG. 22, the configuration tool enables the definition of rules for business process status flow between sub process scenarios (the “Process Status Flow” rules). request The final step in the creation of a new business scenario is to create the corresponding localization program (step 1330). This involves creating a program or function group, including sub-screens for each sub process scenario within the program or function group, using localization 1030 or master data 1040. Next, the sub-screens are assigned to the sub process scenarios, as illustrated in FIG. 19. And finally, a call is placed for the sub-screen for status fields provided by generic workbench 1010. This serves to display the status for each sub process scenario; the implementing ABAP code may look like the following:

```
PROCESS BEFORE OUTPUT.
  MODULE DISPLAY_DATA_CONTAINER.
  CALL SUBSCREEN STATUS_SCREEN
    INCLUDING WB_PROGRAM STAT_SCREEN.
PROCESS AFTER INPUT.
    CALL SUBSCREEN STATUS_SCREEN.
```

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A framework for managing a plurality of business scenarios, comprising:
a generic workbench component configured to provide business process functionality common to each of the plurality of business scenarios;
a localization component configured to provide business process functionality specific to one of the plurality of business scenarios; and
a data exchanger interface component configured to dynamically pass information between the generic workbench component and the localization component,
wherein the generic workbench component centrally manages the business process functionality of the localization component via the data exchanger interface component.

2. The framework of claim 1, further comprising a graphical user interface for concurrently displaying the business process functionality of the workbench component, the business process functionality of the localization component and the current status of the business process functionality of each component.

3. The framework of claim 1, wherein the business process functionality of the workbench component includes request management.

4. The framework of claim 1, wherein the business process functionality of the localization component includes providing localization screens to implement sub process scenarios associated with the specific one of the plurality of business scenarios.

5. The framework of claim 4, wherein the central management by the generic workbench includes status management.

6. The framework of claim 5, wherein the status management includes verification of business process flow between the sub process scenarios implemented by the localization component based on retrieved process status flow rules.

7. The framework of claim 4, wherein the central management by the generic workbench includes business flow rule management.

8. The framework of claim 7, wherein the business flow rule management includes verification of business process flow between the sub process scenarios implemented by the localization component based on retrieved process scenario relationship rules.

9. The framework of claim 1, wherein the data exchanger interface component passes the information by implementing fetch and update operations on the information.

10. A method comprising:
providing a request management screen to an end user for input of a request for a business process scenario;
receiving the request for a business process scenario from the end user;
providing localization screens to the end user for processing sub process scenarios associated with the requested business process scenario;
displaying status information associated with one of the sub process scenarios together with status information associated with the requested business process scenario.

11. The method of claim 10, wherein the particular business scenario is pension administration.

12. The method of claim 11, wherein the sub process scenarios include at least one of performing a seniority calculation, simulating payroll and generating notification reports.

13. The method of claim 10, wherein the particular business scenario is termination.

14. The method of claim 11, wherein the sub process scenarios include at least one of simulating payroll, generating an ETP report, generating a rollover statement and generating group certificates.
